(19) United States
(12) Patent Application Publication
(10) Pub. No.: US 2011/0167948 A1
(43) Pub. Date: Jul. 14, 2011

(54) STEERING COLUMN MODULE INCLUDING A STEERING COLUMN WITH A LONGITUDINAL AND/OR INCLINATION ADJUSTMENT

(76) Inventors: Tobias Andrearczyk, Solingen (DE); Thomas Arndt, Monheim (DE)

(21) Appl. No.: 13/007,239

(22) Filed: Jan. 14, 2011

(30) Foreign Application Priority Data
Jan. 14, 2010 (DE) DE 102010000917.2
Aug. 27, 2010 (DE) DE 102010039896.9

(51) Int. Cl. B62D 1/181

(52) U.S. Cl. 74/493

(57) ABSTRACT

The steering column module for a motor vehicle comprises a steering column and a device for the longitudinal and/or inclination adjustment of the steering column. This device for adjustment comprises a control circuit and is equipped with at least one electric motor of the device for adjustment. The steering column module furthermore comprises a clamping device, which is connected to the control circuit and equipped with an electric motor of the clamping device for the actuation of the clamping device between a normally provided clamping position and a release position. In the method, the clamping device is first actuated until it is in the release position and is held in the release position; only then follows an adjustment of the adjustment device until the desired longitudinal and/or inclination adjustment of the steering column has been reached. Thereafter the clamping device is allowed to go back to the clamping position.

### CROSS-REFERENCE TO RELATED APPLICATIONS

This application claims the benefit of the commonly assigned German Patent Application No. 10 2010 000 917.2 (filed Jan. 14, 2010) and German Patent Application No. 10 2010 039 896.9 (filed Aug. 27, 2010), both of which are hereby incorporated by reference in their entirety.

### FIELD OF THE INVENTION

The invention relates to a steering column module comprising a steering column for a motor vehicle, the steering column module comprising at least one device for the longitudinal and/or inclination adjustment of the steering column, which comprises a control circuit and is equipped with at least one electric motor, and to a method for adjusting a steering column of a steering column module.

### BACKGROUND OF THE INVENTION

A steering column module is described in DE 10 2007 042 737 A1. Moreover, DE 103 01 142 B3, EP 1 767 432 A1 and DE 197 37 036 B1 also show such steering column modules. A steering column module comprises a steering column and a steering column support.

In these known steering column modules, the adjustment forces are relatively high. The electric motor used for longitudinal adjustment and/or the electric motor used for inclination adjustment must therefore be configured to be correspondingly powerful. The steering column module always has to hold the steering column in a crashworthy and clearance-free manner; this is independent from whether an adjustment process is currently in progress or not. The adjustment devices have to be configured such that the set adjustment is retained even in the case of an accident. This requirement leads to the electric motors having to be designed relatively powerful in order to be able to actuate the adjustment device, which is configured to be crashworthy and clearance-free.

However, powerful electric motors are relatively expensive. Normally, one electric motor is used per adjustment device. Therefore, two electric motors are required for an adjustment both in the longitudinal direction as well as in the inclination.

In addition to the steering column module that can be adjusted by means of motors, manually adjustable steering column module are also known; in this regard reference is made only by way of example to DE 196 40 196 C1 and EP 600 700 A1. They serve for enabling a continuous adjustment of a steering column both in its inclination as well as in length. They comprise a clamping device. For an adjustment process, the clamping device is released, then the steering column can be adjusted by the user, and the clamping device is subsequently brought back into the clamping position. The clamping position is the normal state.

In such manually operable steering column modules, the adjustment forces to be applied manually are considerably smaller. There is however the drawback that the steering column is loosened after the clamping device has been released and that further devices are required for somehow holding the loose steering column, for example, by springs. The adjusting movements have to be carried out by hand. However, a great number of users desires a motor-operated adjustment of the steering column within the steering column module. A motor-operated adjustment also makes it possible to set a steering wheel into a preselected position for a certain user if the desired steering wheel position for this user has been stored in advance.

### SUMMARY OF THE INVENTION

Starting from this, it is the object of the invention to further develop the motor-operated steering column module of the type specified in the introduction and the method for adjusting a steering column in a steering column module in such a manner that adjustment can take place with smaller adjustment forces and that, accordingly, electric motors can be used for the adjustment that have a smaller power consumption than the electric motors in motor-operated steering column modules according to the prior art.

The object is achieved by a steering column module of a steering column for a motor vehicle, the steering column module comprising at least one device for the longitudinal and/or inclination adjustment of the steering column, which comprises a control circuit and is equipped with at least one electric motor of the device for adjustment, wherein the steering column module furthermore comprises a motor-operated clamping device, which is connected to the control circuit and equipped with an electric motor of the clamping device for the actuation of the clamping device between a normally provided clamping position and a release position.

Methodwise, it is achieved by a method for adjusting a steering column in a steering column module, the steering column module comprising a device for the longitudinal and/or inclination adjustment of the steering column, which comprises a control circuit and is equipped with at least one electric motor of the device for adjustment, and furthermore comprises a clamping device, which is connected to the control circuit and equipped with an electric motor of the clamping device for the actuation of the clamping device between a normally provided clamping position and a release position; the following steps are successively carried out for the adjustment of the steering column from the clamping position provided in normal operation: actuating the electric motor of the clamping device until the clamping device is in the release position, and holding the clamping device in the release position, actuating the electric motor of the adjustment device until the desired longitudinal and/or inclination adjustment of the steering column has been reached, and actuating the electric motor of the clamping device until the clamping device is back in the clamping position.

A clamping device as it is known from the two aforementioned documents DE 196 40 196 C1 and EP 600 700 A1 can be used as the clamping device. The forces required for releasing such adjustment devices are about 50 N. Relatively small electric motors can be used for this purpose. This also applies to the adjustment devices. Since an adjustment takes place only when the clamping device is released, the work to be applied by the adjustment motor is significantly smaller than in a motor-operated steering column module according to the prior art. The power to be applied for an adjustment is only about ⅓ of that for electric motors according to the prior art. Thus, relatively small electric motors can be used which are currently cheaper by at least 50% than the conventionally used electric motors. Moreover, considerable weight is saved because the smaller motors clearly also have a lower weight.

Finally, space is saved due to the smaller designs of the electric motors in comparison to the hitherto relatively large electric motors.

As compared with the purely manually adjustable steering column modules, the invention is advantageous in that the two adjustment directions can be set independently from each other. In manual adjustment devices, an adjustment in all provided adjustment directions is possible after the clamping device has been released, in particular the longitudinal adjustment and inclination adjustment at the same time, which is not always advantageous for a user.

The invention aims for a single clamping device that releases the steering column in relation to the steering column support, so that the desired adjustments are possible. However, it is also possible to provide a separate clamping device for each adjusting movement.

It is also advantageous that the individual adjustment devices can be configured and constructed to be relatively simple. In particular, they do not have to be clearance-free. They can have a clearance of between 0.05 mm and 0.5 mm. If adjustment takes place, for example, via a spindle drive, then such a clearance can be provided between the spindle and the spindle nut. Moreover, the threaded spindle can now have a core diameter of 3 to 4 mm, whereas in the prior art it so far had a spindle diameter in the range of from 8 to 12 mm. The associated spindle nut can be configured simply; it can be produced, for example, from a simple plastic, such as POM or PA. It does not have to be reinforced, and also need not be provided with a lubricant. On the whole, drives with a very simple structure can be used. The drives are only required and used for the adjusting movement; they do not have any task in the event of an accident. Crash worthiness is achieved by means of the clamping device. This does not exclude the adjustment device from also receiving a part of the crash forces.

Preferably, the electric motors used are constructionally identical. Preferably, the electric motors used have a volume which is maximally 70%, preferably maximally 50% of the volume of a motor as it is currently used for steering column modules according to the prior art.

Preferably, a circuit is provided in the control circuit, which prevents that the electric motor of the clamping device can be supplied with power so long as at least one of the electric motors for an adjustment device is supplied with power, and vice versa.

Other advantages and features of the invention become apparent from the other claims as well as from the following description of an exemplary embodiment of the invention, which shall be understood not to be limiting and which will be explained below with reference to the drawing.

### BRIEF DESCRIPTION OF THE DRAWINGS

FIG. 1 shows a perspective view of a steering column module with a steering column viewed at an angle from the front and from above; the x-y-z coordinates for the associated vehicle are drawn in, with the x-direction being the normal driving direction, the y-direction lying in the driving plane, and the z-direction pointing up perpendicularly;

FIG. 2 shows a partial section of FIG. 1 concerning the clamping device in an enlarged scale; and

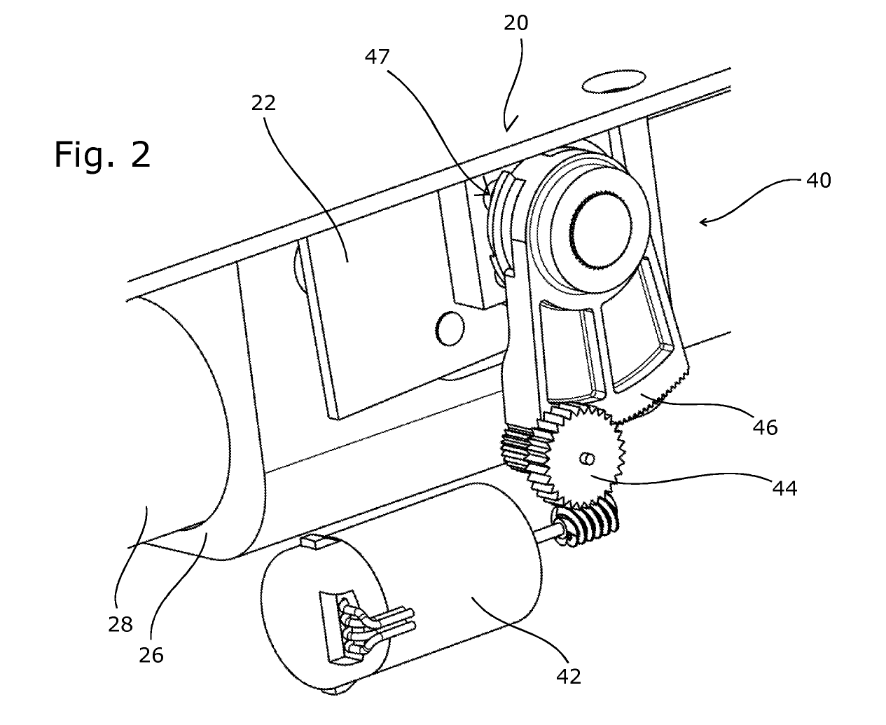

FIG. 3 shows a detail from FIG. 1 in the form of an assembly illustration, again looking onto the clamping device.

### DETAILED DESCRIPTION OF THE PREFERRED EMBODIMENTS

The applicants expressly reserve the right to combine features and also sub-features of individual claims in any way, even if they do not refer to one another, and also to combine features and also sub-features of at least one claim in any way with features and/or partial features from the description, and to combine features and also sub-features from the description with one another.

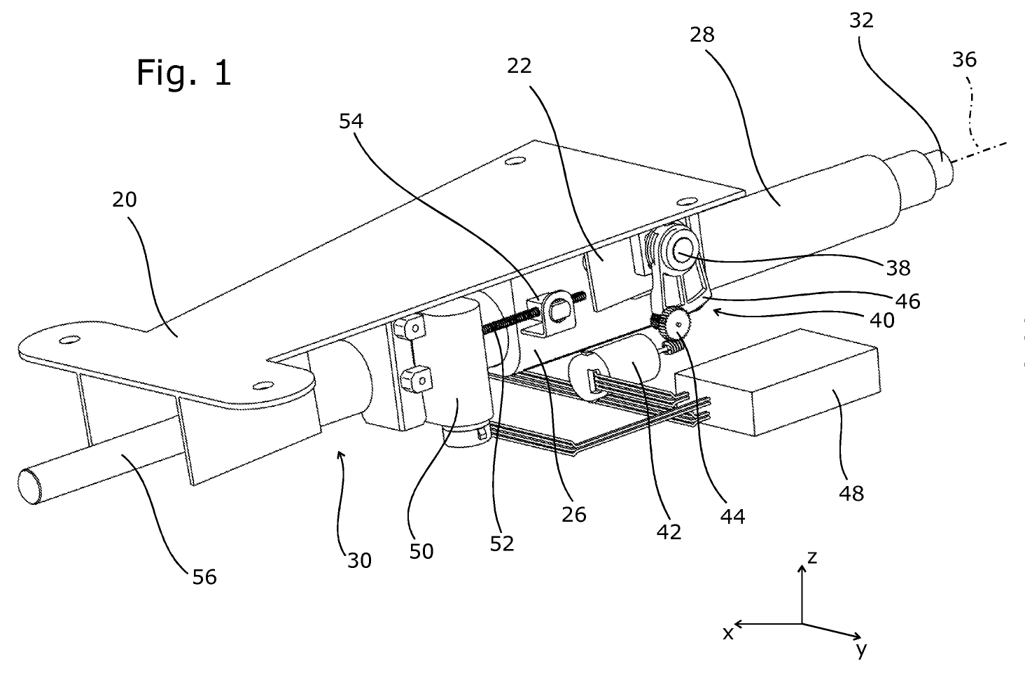

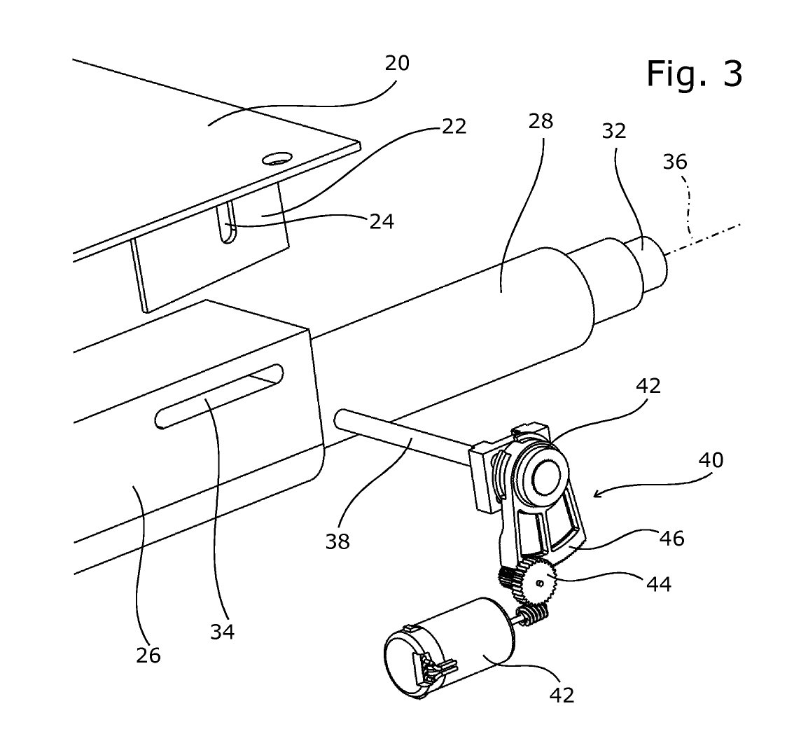

The steering column module shown in the Figures comprises a bearing block 20 comprising fastening means for mounting underneath a dashboard of a motor vehicle (which is not shown in this case). It forms two upper supports 22 that are oriented substantially in the x-z-plane. Elongated holes 24 are provided therein, see FIG. 3. These elongated holes 24 have a long axis and a short axis. A jacket tube 26, which hereinafter is referred to as a guide member 26, is located underneath the bearing block 20. It grips an upper spindle part 28, hereinafter referred to as jacket tube 28, of a steering column 30. The guide member 26 and the jacket tube 28 are firmly connected to each other. A steering wheel accommodation 32 is provided on the end portion, which in FIG. 1 and FIG. 3 is on the right; a steering wheel (not shown) can be attached here. The guide member 26 has a longitudinal opening 34 which extends offset by about 90° to the longitudinal direction of the elongated hole 24 and has a long axis and a short axis. The long axis of the longitudinal opening 34 extends parallel to an axis 36 of the steering column 30 and parallel to the y-direction.

The guide member 26 is located between the two upper supports 22 which abut against it. A clamping bolt 38 extends through the two elongated holes 24 of the upper supports 22 and the longitudinal opening 34. It is a part of a clamping device 40 to be described below. Normally, it is in a clamping state. In the clamping state, the supports 22 abut against the guide member 26 on both sides in a positive fit and/or force fit and hold the guide member 26 between themselves. This clamping force is obtained as follows:

An electric motor 42 of the clamping device 40 drives a worm gear 44 via a worm. The output shaft of this electric motor 42 substantially extends parallel to the direction of the axis 36, but can also be oriented in another direction. The worm gear 44 is rotationally connected to a drive sprocket which meshes with a sector-shaped toothed part 46. This toothed part 46 constitutes the hand lever in the known manually operated clamping devices. Thus, designs as they are known, for example, from the above-mentioned prior art for clamping can be adopted and used for the other parts. Express reference is hereby made to their content in its entirety. In particular, a clamping mechanism 47 as it is known for manual adjustment from one of the two aforementioned documents can be used.

The electric motor 42 is electrically connected to a controller 48.

Furthermore, the steering column module comprises a device for the longitudinal adjustment of the steering column 30. For this purpose, an electric motor 50 of the longitudinal adjustment device is disposed on the guide member 26, alternatively on the jacket tube 28. It drives a spindle 52 that extends parallel to the axis 36. It extends parallel to the longitudinal opening 34. It engages into a spindle nut 54 which is disposed on the guide member 26 by means of an L-shaped angle bracket. In this case, the angle bracket has a leg that extends parallel to the x-z-plane and in which a circular hole is formed. A portion of the spindle nut 54 extends through this hole. The spindle nut 54 can thus pivot about an axis that is parallel to the y-direction.

The motor 50 is also connected to the controller 48. Finally, a third connecting line is provided on the controller 48; it leads to an electric motor for an inclination adjustment not shown in the Figures. This electric motor is connected to the controller 48 also in this way. It is located on the side of the steering column 30 opposite from the electric motor 50. The electric motor for the inclination adjustment can be fixed directly on the bearing block 20, it can, in turn, comprise a spindle and a spindle nut, just like the longitudinal adjustment device shown, but offset by 90°. The spindle of the inclination adjustment preferably extends parallel to the elongated hole 24. Again, an L-shaped angle bracket can be used which also has a flange which extends in the plane parallel to the x-z-direction and in which a circular opening is formed. The angle bracket is now offset by only 90° relative to the angle bracket for the longitudinal adjustment.

The bearing block 20, its front supports 22 and the guide member 26 as well as the clamping device 40 and the two adjustment devices are part of a steering column support. The steering column 30 extends through this steering column support. The steering column support and the steering column 30 together form the steering column module. The steering column 30 is comprised of the jacket tube 28 and a lower spindle part 56. Both are displaceable relative to each other in the direction of the axis 36, but are non-rotatable.

An adjustment process is described in the following: In the normal state, all electric motors are currentless; the clamping device is in the clamping position. If one or the other of the electric motors of an adjustment device were now to be supplied with voltage, no adjusting movement would take place. An adjustment against the clamping state is possible neither for the longitudinal adjustment device nor for the inclination adjustment device.

Before an adjustment takes place, the clamping device must be released. For this purpose, the motor 42 of the clamping device is activated by the controller 48. It brings the clamping device into the release position and keeps it there. It is not until the release position is reached that at least one of the electric motors 50 for the adjustment devices can be actuated. For example, if the electric motor 50 of the longitudinal adjustment device is actuated, a corresponding adjustment of the jacket tube 28 relative to the lower spindle part 56 takes place. If the longitudinal adjustment is completed, the state reached is secured by the clamping device now being actuated again. The electric motor 42 is actuated until the clamping device has reached the clamping position again. The adjustment process is now complete.

The motors for the adjustments can be operated at the same time, i.e. parallel, but also successively. The two spindle drives can be constructionally identical, or largely constructionally identical in any case. Preferably, the adjustment devices are equipped with path detection or the like, so that the current position can be detected and stored in a memory of the controller 48. A so-called memory is thus possible. It is also possible to bring a steering wheel into a comfortable position, for example to facilitate getting into the vehicle.

The spindle nuts are preferably made from simple plastic, for example POM or PA. They do not require any bracing or reinforcement. No lubricant additive is necessary, either. The spindles 52 have a core diameter of 2 to 5 mm, preferably of 3 to 4 mm. There can be a clearance of between 0.01 and 0.5 mm, preferably of between 0.05 mm and 0.3 mm between the spindle nut 54 and the spindle 52.

A logic unit which prevents the electric motor 42 from being actuated at the same time as an electric motor 50 of an adjustment device is preferably provided in the controller 48. Furthermore, a logic unit is preferably provided which always actuates the clamping device 40 before and after an adjusting movement.

The invention is advantageous in that the steering column is always fixed in the steering column support via the motor-operated adjustment devices. In contrast to manual steering modules, the steering column thus does not become virtually completely free. A manual adjustment remains precluded due to the adjustment devices, an adjustment must always be carried out by means of at least one electric motor of the adjustment device. For a user, this is reflected in a higher comfort than in a manual device.

In the known manner, the steering column module comprises a trigger with which an adjusting movement can be initiated and terminated. For example, a push surface is provided on the steering wheel, which is disposed similar to the push button for the horn and which must be pressed if an adjustment is to take place. The adjustment direction is determined by inclination in the desired adjustment direction. Or sensor surfaces are provided on the steering wheel. In another embodiment, four keys are arranged in the shape of a cross. When one of the keys is actuated, the adjustment takes place in the direction indicated by the cross shape. Solutions as they are already known from the prior art for motor-operated steering column modules can be used for the inputting means.

The applicants reserve the right to combine any features and also sub-features from individual sentences of the description and/or from the claims with one another in any way, even if such a combination has not been discussed directly and/or is not directly specified by the reference of the claims.

What is claimed is:

1. A steering column module for a motor vehicle comprising:
a steering column and at least one device for adjustment of the steering column, the device for adjustment including a control circuit and at least one electric motor of the device for adjustment, wherein the steering column module further comprises a clamping device, the clamping device being connected to the control circuit and equipped with an electric motor of the clamping device for the actuation of the clamping device between a normally provided clamping position and a release position.

2. The steering column module according to claim 1, wherein the device for adjustment comprises at least one spindle drive having a spindle and a spindle nut.

3. The steering column module according to claim 1, wherein the device for adjustment comprises at least one spindle drive, the spindle drive comprises a spindle and a spindle nut, and the spindle has a core diameter of one of between two to six and between three to four mm.

4. The steering column module according to claim 1, wherein the device for adjustment comprises a retaining clamp and at least one spindle drive, the spindle drive comprises a spindle and a spindle nut, and the spindle nut is movably held in the retaining clamp.

5. The steering column module according to claim 1, wherein the steering column module comprises an elongated hole, the device for adjustment comprises at least one spindle drive, the spindle drive comprises a spindle and a spindle nut, and the spindle extends obliquely to a direction of a long axis of the elongated hole.

6. The steering column module according to claim 1, wherein the device for adjustment is a device for at least one of longitudinal and inclination adjustment.

7. The steering column module according to claim 2, wherein a clearance of one of between 0.01 and 0.5 mm and between 0.05 and 0.3 mm is present between the spindle and the spindle nut.

8. The steering column module according to claim 1, wherein the device for adjustment comprises a retaining clamp and at least one spindle drive, the spindle drive comprises a spindle and a spindle nut, and the spindle nut is pivotably held in the retaining clamp.

9. The steering column module according to claim 1, wherein the steering column module comprises an elongated opening, the device for adjustment comprises at least one spindle drive, the spindle drive comprises a spindle and a spindle nut, and the spindle extends parallel to the direction of a long axis of the longitudinal opening.

10. A method for adjusting a steering column in a steering column module, the steering column module comprising a device for adjustment of the steering column, the device for adjustment comprises a control circuit, at least one electric motor of the adjustment device and a clamping device, the clamping device being connected to the control circuit and equipped with an electric motor of the clamping device for an actuation of the clamping device between a normally provided clamping position and a release position, the method comprising:
beginning from the clamping position, actuating the electric motor of the clamping device until the clamping device is in the release position, and holding the clamping device in the release position;
actuating the electric motor of the adjustment device until the desired longitudinal and/or inclination adjustment of the steering column has been reached, and
actuating the electric motor of the clamping device until the clamping device is back in the clamping position.

11. The method according to claim 10, wherein the steps are performed successively.
